(19) United States
(12) Patent Application Publication
(10) Pub. No.: US 2011/0196703 A1
(43) Pub. Date: Aug. 11, 2011

(54) Artificial social engine

(75) Inventor: Vladimir Trakhtman, New York, NY (US)

(73) Assignee: Vladimir Trakhtman, New York, NY (US)

(21) Appl. No.: 12/658,441

(22) Filed: Feb. 8, 2010

(51) Int. Cl. G06Q 50/00; G06Q 10/00; G06Q 40/00; G06Q 99/00

(52) U.S. Cl. 705/3; 705/2; 705/4; 705/329

(57) ABSTRACT

A business is contracted by a budget or another business to execute a non profitable deal like public health care by a managerial art to minimize costs. The costs will be compensated by a contractor while surplus value would be given the executor indirectly (administratively, politically etc.).

### CROSS-REFERENCE TO RELATED APPLICATIONS

Not applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to the domain of commerce adjusted to deal in public health care (PHC) and other social deals that need less costs. This problem relates to current U.S. Classes 705/163, 705/36T, 705/19, 705/31, 705/14.48,705/2 and touches, accordingly, business, tax strategies/processing/preparation and activities basing upon budgeting like health care management.

Known commerce is formed historically basing on natural human needs and possibilities. On FIG. 1, it is represented by the block 1 of a business which contains the block 10 of commerce, the block 30 of technology to prepare goods and services for commerce and the block 20 of a managerial art to get less costs and to increase income. A non profitable service like PHC is served by the budget 2 which contains the political block 50, the block 40 of taxation and the block 60 of a non profitable deal. Financial resources to serve the budget are taken by taxation from business 1, the block 10 of commerce of the business.

To understand this scheme better, it could be interpreted like a social engine as it is done at the brochure with the same name written by the author of the present invention. A business is shown on FIG. 2 with the block 1 similar to the block 1 on FIG. 1. It contains the block 10 of commerce, the block 30 of technology and the block 20 of a managerial art. But on FIG. 2 forces are shown by arrows and fists to compete on a market (10f), to increase costs (30f) and to fight against costs (20f). The force 10f belongs to the block 10 of commerce. The force 30f belongs to the block 30 of technology. The force 20f belongs to the block of managerial art 20.

A budget is shown on FIG. 2 by the block 2 similar one on FIG. 1. It contains the block 60 (for example, PHC), the same as the block 60 inside the block 2 on FIG. 1. Inside the block 60, there is the block 60A to execute regular duties of PHC and the block 60B to represent the force oriented to increase costs expenses and correspondent forces 60Af and 60Bf. No special force is fighting inside budgeting against increasing cost expenses.

The patent application “Tax Insurance Method, and System” Ser. No. 12/154,553 from May 22, 2008, the same author Vladimir Trakhtman, treats absence of such force like a disadvantage. A force is demanded to keep productivity and effectiveness of PHC or any other non profitable budgeted deal by pressing personnel and minimizing cost expenses. It should be the force similar one applied by a business like a managerial art 20f (FIG. 2).

Commercial providers are offered by said patent application to put the force of a managerial art inside budgeting and to press every budget duty getting less costs. The disadvantage of this invention it offers an element of a business inside budgeting. It is unusual and is oriented toward the future because human practice does not know similar providers so far. It is just disadvantage because, for example, such social problem as PHC waits for an immediate decision because millions of poor people live without a proper medical help while commercial providers inside budgeting could appear not so soon.

To improve the disadvantage, apply another interpretation of the pair a market and budget. Interpret this like much more simple pair made from a customer (a budget) who needs a service (for example, a cheap PHC) while a seller of services (a market) offers something else.

But the customer (a budget) has money (gotten by taxation) and administrative possibilities to hire a service demanded. Actually, a managerial art of a business is demanded to press available PHC like a technology for less costs. Nothing new is in such a service. Every business applies a managerial art like its own internal activity. The problem is such service needs income or surplus value like an independent business but it contradicts to the task to get PHC for less costs.

### BRIEF SUMMERY OF THE INVENTION

A business is contracted by a budget or another business to execute a non profitable deal like public health care by a managerial art to minimize costs. The costs will be compensated by a contractor while surplus value would be given the executor indirectly (administratively, politically etc.).

### BRIEF DESCRIPTION OF THE SEVERAL VIEWS OF THE DRAWINGS

FIG. 1 is the block scheme of known productive/financial human activity

FIG. 2 is the block scheme of another interpretation of known productive/financial human activity

FIG. 3 is the block scheme in accordance with the present invention.

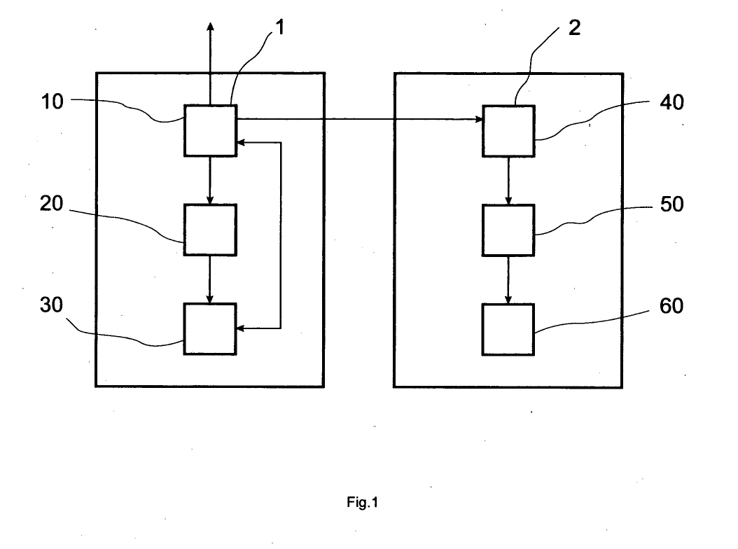

On the FIG. 1:
1—business
10—commercial block of the business
20—block of a managerial art of the business
30—block of technology of the business
2—block of budgeting
40—block of taxation
50—block of political activity
60—block to execute a social task like PHC

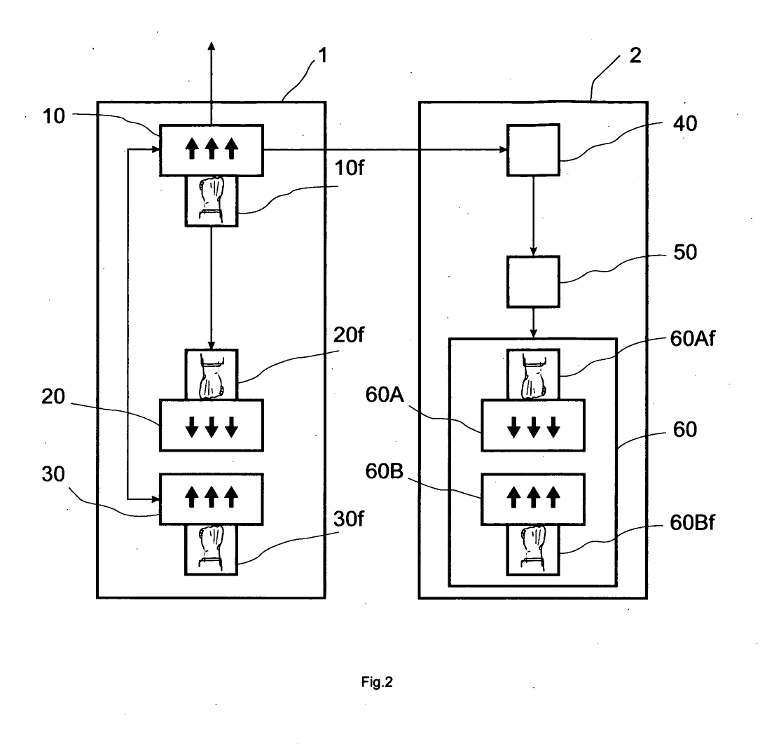

On FIG. 2:
1—business engine
10—commercial block of the business
10f—commercial force of the business
20—block of a managerial art of the business
20f—managerial force of the business
30—block of technology of the business
30f—force of a side effect of the business
2—budget engine
40—block of taxation
60—block of a social task like PHC
60A—block to execute the social task
60Af—force to execute the social task
60B—block of a side effect of budgeting
60Bf—force of the side effect of budgeting

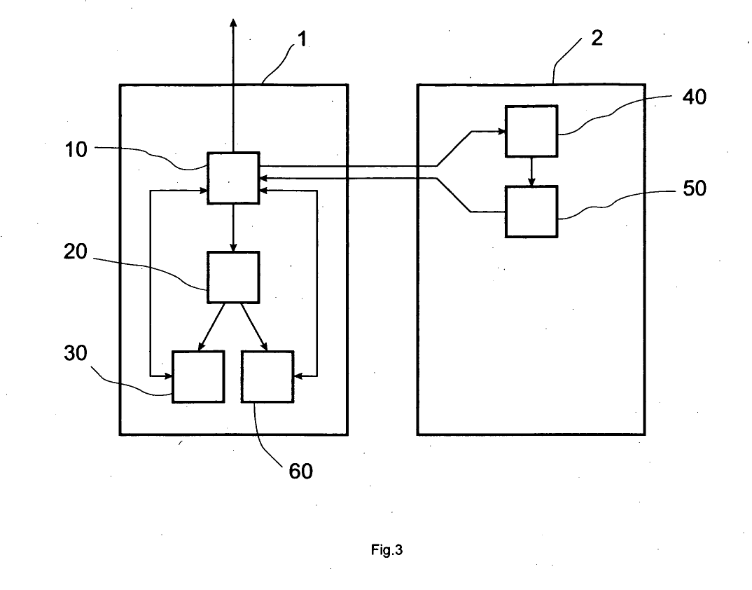

On the FIG. 3:
1—business
10—commercial block of the business
20—block of a managerial art of the business
30—block of technology of the business
60—block of a social task like PHC
2—block of budgeting
40—block of taxation
50—block of political activity

### DETAILED DESCRIPTION OF THE INVENTION

The main embodiment of the present invention concerns public health care PHC and is based on a contract established by a municipal and/or state and/or federal authorities (a contractor)—from one side, and a business (an executor)—from another side, to serve PHC at cost price, without getting income or surplus value.

To attract a commercial interest of the executor, the contractor offers a non-financial partnership. It may concerns a permissions to take a game business, lottery, a license to develop a project etc. Activities of authorities of such a kind are not regulated specially right now. It may be done like a payable service to fulfill a budget, a political decision or even an act of corruption.

But this stuff is a great non financial resource to establish a socially useful partnership with a business and, for example, to hire the business to execute a medical service for cost price applying the same managerial instrument that is used by this business to keep its own minimal costs. If a business keeps a service like a medical one at prime cost (not taking financial surplus value of this activity), the business appears socially oriented. A partnership of authorities with such under-half-business denotes appearance of a new kind of a social organization. It may be useful to both partners: authorities (it means, entire society) and the business who agrees to serve society by socially useful under-half of its own business (call such business like under-business). It is the way to bring society more concordance and less taxation.

The interest of authorities is naturally focused on social duties like PHC realized at minimal price. But a regular business could not serve clients at minimal price. A business needs income (surplus value). It is gotten by internal and external efforts. Internal ones include a managerial skill to minimize costs and maximize price. External efforts are based on a competition with similar businesses.

Paradoxically, a regular business looks naturally until resolves a social task at cost price (like under-business mentioned above) and taxation looks naturally but budget bureaucracy is very expensive and a social problem resolving by budget bureaucracy is very expensive.

It has no sense. The present invention offers an artificial (non natural) three-half-business with an additional under-business to resolve a social problem at cost price (compensated by a budget). Of course, the executor keeps its own business to get regular income. Additionally the executor would be compensated by non-financial preferences of the budget. It is the way to resolve social problems for cost price and to minimize taxation.

This decision of the present invention is considered to be a temporal one. A social business for prime cost (call it an inverse one in comparison with a regular/direct business) can not compete with a correspondent regular business right now because the direct business has the preference of initiative. The business does not ask income/surplus value. It takes the income/surplus value by force. Actually, a business takes income/surplus value applying managerial skill.

But when the new technology reveals a real cost of PHC, a correspondent inverse technology win a competition against the regular direct one. It means, the competition would begin between different executors of PHC for cost price to share a great medical financial resource. And the inverse technology would become profitable for those who win the competition.

It should be said that appearance of so-called inverse commerce (offered by the inventions of the author) makes clear a philosophic aspect of which is income/surplus value and capitalism based on said income/surplus value.

It is well-known that capitalism is an unfair activity to get income/surplus value for the cost of clients (customers) and employees. Indeed, it is a real fact but simultaneously—it is a mistake. The point is a social structure is made from people like technical parts. Like the parts, people should be estimated dependently. But people do not estimate themselves dependently and it is supported by numerous sociologists. Capitalism appears blamed for its income/surplus value to be taken as if for the cost of people (clients and employees of the business). But it is not so actually even if the income/surplus is taken just for the cost of people. But the people are at this case only parts of a social structure. Not entire capitalism but a stricture of capitalism (a managerial art) should be blamed or not blamed for getting income/surplus value for the cost of people. The managerial art is one of the highest achievements of humanity and it is blamed. Something wrong is in this situation.

The present invention estimates the managerial skill of a business and the possibility of the business to apply said managerial skill to press salaries and other benefits of a personnel like an exceptionally useful social mechanism which is not understood completely because a proper social system is not invented yet. The present invention makes first steps in this direction.

Ideologies like socialism and communism confuse people and structures made from people (technical parts of the structures). Ideologies like socialism and communism are oriented to help people but act against useful social structures, the only means to help people. Human society does not deal now in a person, it deals in many people, collectives of people, the same, it deals in social structures. Until people are served collectively, they should be estimated collectively, like structures.

In terms of structures and systems, said managerial skill of a business is oriented against an unavoidable side effect of a business. It is an exceptionally useful activity absolutely natural in sense of physics (like an activity against a friction).

Mathematically, to see people on the place of an unavoidable side effect created by the people means to overcome exactness on a description of an essence and to destroy the description of the essence (here—the side effect) by a noise around the essence. Physically, it looks like applying a microscope instead of a telescope looking on a star on the sky.

Of course, a current practice of capitalism should be blamed, correctly, the practice of some direct businesses, for example, medical ones should be blamed. The present invention offers to keep medical practice like an inverse business, not a direct one. If a market of correspondent (for example, medical) deals appears an inverse one almost entirely, it would become at a time social and profitable because one inverse medical business becomes the possibility honestly compete with another medical inverse business for a common medical financial resource of all customers together. It is the way to get income/surplus value by external business efforts keeping internal ones on the level of cost price. There is nothing like an unfair medical capitalism. It would be a fair capitalism in respect to medicine.

The present invention offers a specific commerce by just the managerial business skill able to minimize costs of PHC, other social tasks. But right now it could be realized non financially only because direct medical commerce is too strong right now.

To overcome the strong medical direct business, the present invention offers actually the behavior of the bird cuckoo. This bird abandons its eggs at the nest of a bird of another kind.

So, public health care could be abandoned at the nest of a business like an under-business in respect to its own one. It could be done for the cost of definite non financial preferences from the side of authorities. It is the way to satisfy interests of both sides of this deal. The authorities would get PHC at cost price while the business to prepare such PHC would get its own preferences (other than financial ones) that could be very useful but do not increase the cost of PHC.

The same method could be applied to get a medical insurance at cost price. It could be applied to increase efficiency of whatever another service if it is demanded. And of course, it could be applied by any business to resolve a problem by hiring another business like an under-business.

The scheme to implement the present invention is represented on FIG. 3. The block of a business 1 contains the block of commerce 10, the block of a managerial art 20 and the block of its own business technology 30. Additionally, the block 60 of a social technology like PHC is inserted into the block 1.

The budget block 2 represents authorities. It contains the block 40 of taxation and the political block 50. Conditionally, the block 2 is represented without a social duty 60 because, suppose, the duty PHC (the block 60) is replaced into the position inside the business block 1. Business 1 executes its own business applying commercial block 10, technological block 30 and the block of a managerial art 20 in such a way that the block 20 minimizes internal costs of the business while the block 10 maximizes pricing. In accordance with a contract established by authorities (the block 2) with the business (the block 1), a social duty 60 like PHC is replaced from the block 2 into the block 1 and inserted under the influence of the block 20 of a managerial art like the technology of the business (the block 30). All information about said block 60 (PHC) is going to the commercial block 10 like it is going at the block 10 from the block of technology 30.

But the block 10 does not keep a commerce with PHC. It sends instead information about PHC to block 2 of authorities to get back a proper compensation, financial in respect to real costs of PHC and non financial one like an indirect income or surplus value for serving PHC. Besides executing concrete medical needs (it is explained above), the problem of PHC demands a serious strategic attention in respect to insuring. Mostly, it should be a mathematic attention, the attention to numbers. Commercial medicine keeps its important secrets while a social and public service demands publicity. The present invention offers the system to collect/process medical statistics or data to get entire picture of a public medical service and to arrange public health care properly.

Actually, it is the statement that PHC is not organized properly right now. Medical insurance of people is not accompanied by proper medical insurance of medical organizations/hospitals. In result, people pay premiums the insurances including all expenses of medical organizations/hospitals. But, for example, repairing a roof of a building or clearing rooms is not an illness of a human being.

To make clear this aspect, the present invention offers a general budget unite of public health care which contains an apparatus of data processing, means for inputting instructions, means to connect said apparatus with similar apparatus and similar means on the level of multiple municipal and/or state and/or federal contractors of public health care each connected with apparatus and similar means on the level of executors of public health care.

The task is to reveal a real cost price of a medical service, to get detailed cost sheets and to arrange a proper social environment including a medical part of taxation, rules and regulations concerning medical insurance and accessing/pricing different groups of people in respect to the system of PHC.

There is a deep theoretical problem which has a great practical sense. It concerns the fact which could be unknown by non specialists like politicians etc. Medical pricing is not a usual pricing of something in a shop. Medical pricing could not be described by a single set of numbers like a price of usual goods/services. If a medical price is described by a single number, it is the sign something is wrong and somebody takes non fair income.

It is because medical pricing is based on insurance. The insurance smoothes a financial trouble like an illness which may cost definitely more to be cured. People pay premiums regularly to help a part of themselves who catch a medical trouble. Calculations of insuring are based on so called distributions of probabilities. But is should be the distribution of illnesses, not roofs to be repair.

A flu has its own distribution, a cancer has its own one, repairing a roof of a hospital has its own probability as well. The point is this aspect is kept by insurances like the most important secret because it is a great source of an unfair income to be gotten if a regular maintenance of a hospital is calculated by a bill of a patient and goes to an insurance like a random event like an illness. This aspect should be strictly controlled by authorities and proper decisions should be taken.

A contract to serve PHC implies a financial and managerial control of a medical organization or hospital or a medical insurance in respect to medical numbers as well as distributions of probabilities of the numbers. It makes a medical budgeting much more sophisticated. In accordance with the budget, medical expenses should be compensated by the contractor. Let the contractor compensate the expenses in accordance with said distribution of probabilities. Now, it is a function of insuring only. The present invention offers more attention of authorities to this aspect. It is an important aspect on the way to minimize medical costs.

I claim:

1. An artificial social engine to minimize costs of health care and to distribute this service at cost price thanks to a partnership of a municipal and/or state and/or federal authorities (called below as a contractor) and a business (called below as an executor or under-business) comprises a contract between the partners comprises:
the contractor to hand a medical organization/hospital over managerial/financial control of the executor;
the contractor to estimate cost price of the contract including a cost sheet of salaries of a personnel and to turn a correspondent budget over the executor;
the contractor to hand over the executor rules and regulations concerning an access of patients to said medical office/hospital;
the contractor to control current expenses of both said medical office/hospital and the executor;
the contractor to compensate costs of both the medical organization/hospital and the executor to manage the medical organization/hospital;
the contractor to give the executor like a surplus value non financial (political, administrative, technological) preferences;
the contractor to collect date concerning managing said medical organization/hospital;
the contractor to represent said date by requests;
the executor to establish rules and regulation of interactivity with the personnel of said medical office/hospital comprising:
subordinating the personnel to managerial/financial efforts of the executor;
subordinating the executor to medical efforts of the personnel;
resolving possible conflicts under the patronage of the contractor
initiating additional contracts with the contractor concerning managerial novelties, wear and tear and possible developing medical technology;
the executor to keep a current budget and to develop further managerial improvements;
the executor to keep correspondent financing and controlling operations;
the executor to permit audits and other controlling function under the direction of the contractor;
the executor to take penalties if said rules and regulations are violated;
the executor to keep its initial business independently from the contract;
the executor to collect data concerning managerial medical organization/hospital in accordance with given recommendations;
the executor to represent said data by requests;
the contractor and the executor to execute said contract

2. A method of claim 1 with a contractor-business.

3. A method of claim 1 with a medical insurance as an object of a contract.

4. A method of claim 1 with patients constantly attached to said medical organization/hospital to be managed by the executor more effectively comprising:
getting medical history of the patients
uniting functions of insuring/curing to be processed at cost price.

5. A method of claim 1 to keep cost sheets of data separately about:
regular maintenance expenses;
occasional maintenance;
instrumental medical developing
current expenses to serve patients.

6. A method of claim 1 for a contractor to establish additional compensation of an executor in accordance with further minimizing cost price of the contract.

7. A method of claim 1 to manage an arbitrary social budget duty by similar contract.

8. A method of claim 1 to manage a critical commercial activity by a similar contract.

9. A method of claim 1 for a medical enterprise at cost price and surplus value of this commerce by competition with similar enterprises.

10. An artificial social engine of public health care comprises:
a general budget unit of public health care data comprising:
apparatus of data processing medical managerial information;
means connected to said apparatus for inputting instructions;
inputting instructions to said apparatus;
means of communication with multiple budget contractors of public health care;
multiple municipal and/or state and/or federal units of public health care data each comprises:
apparatus of data processing medical managerial information;
means connected to said apparatus for inputting instructions;
inputting instructions to said apparatus;
means of communication with executors of public health care;
means of communication with a general budget unit of public health care;
multiple under-business units of public health care data each comprising:
apparatus of data processing medical managerial information;
means connected to said apparatus for inputting instructions;
inputting instructions to said apparatus for establishing contracts
said apparatus having regulatory requirements to manage a medical service stored therein;
inputting instructions to said apparatus to produce banking, financing and controlling operations as well as calculating and recalculating financial and other data.

11. A system of claim 10 to keep separately data concerning illnesses of patients and maintenance of medical organizations/hospitals with different insuring correspondent events.
